(19) United States
(12) Patent Application Publication
(10) Pub. No.: US 2015/0334547 A1
(43) Pub. Date: Nov. 19, 2015

(54) DEVICE IDENTIFICATION SYSTEM AND METHOD

(71) Applicant: Google Inc., Mountain View, CA (US)

(72) Inventor: RYAN JAMES LOTHIAN, London (GB)

(73) Assignee: Google Inc., Mountain View, CA (US)

(21) Appl. No.: 14/058,703

(22) Filed: Oct. 21, 2013

(51) Int. Cl. H04W 8/00

(52) U.S. Cl. CPC H04W 8/005

(57) ABSTRACT

A method and computing system for monitoring, on a first device coupled to a wireless network, wireless communication between a second device and a third device. A wireless transmission is received on the first device. The wireless transmission is from the second device to the third device. The wireless transmission is processed to extract a device identifier from the wireless transmission, thus defining an extracted device identifier. The extracted device identifier is compared to one or more known device identifiers, wherein each of the known device identifiers is associated with a known user. If the extracted device identifier matches a specific device identifier, included within the known device identifiers, the known user that is associated with the specific device identifier is identified.

### TECHNICAL FIELD

This disclosure relates to device identification and, more particularly, to device identification within a wireless network.

### BACKGROUND

People often use smart phones and other client electronics devices (e.g., tablet computers and personal digital assistants) to stay in touch and communicate with each other. On these devices, the users may define their friends, colleagues, and acquaintances within a contact list, thus making it easier for people to stay in touch with each other.

These client electronic devices may be configured to interface with and couple to wireless networks (e.g., Wi-Fi networks). When coupled to such wireless networks, these devices may communicate with each other based upon their MAC addresses, wherein a MAC address is an identifier that uniquely identifies each device that may be coupled to the wireless network. When communicating on these wireless networks, data may be transmitted as data frames; wherein the transmitter of a data frame may be identified by the MAC address of the transmitting device and the intended recipient of the data frame may be identified by the MAC address of the intended recipient.

### SUMMARY OF DISCLOSURE

In one implementation, a computer-implemented method includes monitoring, on a first device coupled to a wireless network, wireless communication between a second device and a third device. A wireless transmission is received on the first device. The wireless transmission is from the second device to the third device. The wireless transmission is processed to extract a device identifier from the wireless transmission, thus defining an extracted device identifier. The extracted device identifier includes a MAC address. The extracted device identifier defines one of a transmitter of the wireless transmission and an intended recipient of the wireless transmission. The extracted device identifier is compared to one or more known device identifiers stored within the first device. Each of the known device identifiers is associated with a known user. If the extracted device identifier matches a specific device identifier, included within the known device identifiers, the known user that is associated with the specific device identifier is identified.

In another implementation, a computer-implemented method includes monitoring, on a first device coupled to a wireless network, wireless communication between a second device and a third device. A wireless transmission is received on the first device. The wireless transmission is from the second device to the third device. The wireless transmission is processed to extract a device identifier from the wireless transmission, thus defining an extracted device identifier. The extracted device identifier is compared to one or more known device identifiers, wherein each of the known device identifiers is associated with a known user. If the extracted device identifier matches a specific device identifier, included within the known device identifiers, the known user that is associated with the specific device identifier is identified.

One or more of the following features may be included. The wireless transmission may include at least one data frame. The second device and the third device may be coupled to the wireless network. At least one of the second device and the third device may be a client electronic device. At least one of the second device and the third device may be a wireless access point. The extracted device identifier may define a transmitter of the wireless transmission. The extracted device identifier may define an intended recipient of the wireless transmission. The extracted device identifier may include a MAC address. The known device identifiers may be stored within the first device.

In another implementation, a computing system including a processor and memory is configured to perform operations including monitoring, on a first device coupled to a wireless network, wireless communication between a second device and a third device. A wireless transmission is received on the first device. The wireless transmission is from the second device to the third device. The wireless transmission is processed to extract a device identifier from the wireless transmission, thus defining an extracted device identifier. The extracted device identifier is compared to one or more known device identifiers, wherein each of the known device identifiers is associated with a known user. If the extracted device identifier matches a specific device identifier, included within the known device identifiers, the known user that is associated with the specific device identifier is identified.

One or more of the following features may be included. The wireless transmission may include at least one data frame. The second device and the third device may be coupled to the wireless network. At least one of the second device and the third device may be a client electronic device. At least one of the second device and the third device may be a wireless access point. The extracted device identifier may define a transmitter of the wireless transmission. The extracted device identifier may define an intended recipient of the wireless transmission. The extracted device identifier may include a MAC address. The known device identifiers may be stored within the first device.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a wireless network including a client electronic device that executes a device identification process according to an implementation of the present disclosure; and

FIG. 2 is a flowchart of the device identification process of FIG. 1 according to an implementation of the present disclosure.

Like reference symbols in the various drawings indicate like elements.

### DETAILED DESCRIPTION OF THE PREFERRED EMBODIMENTS

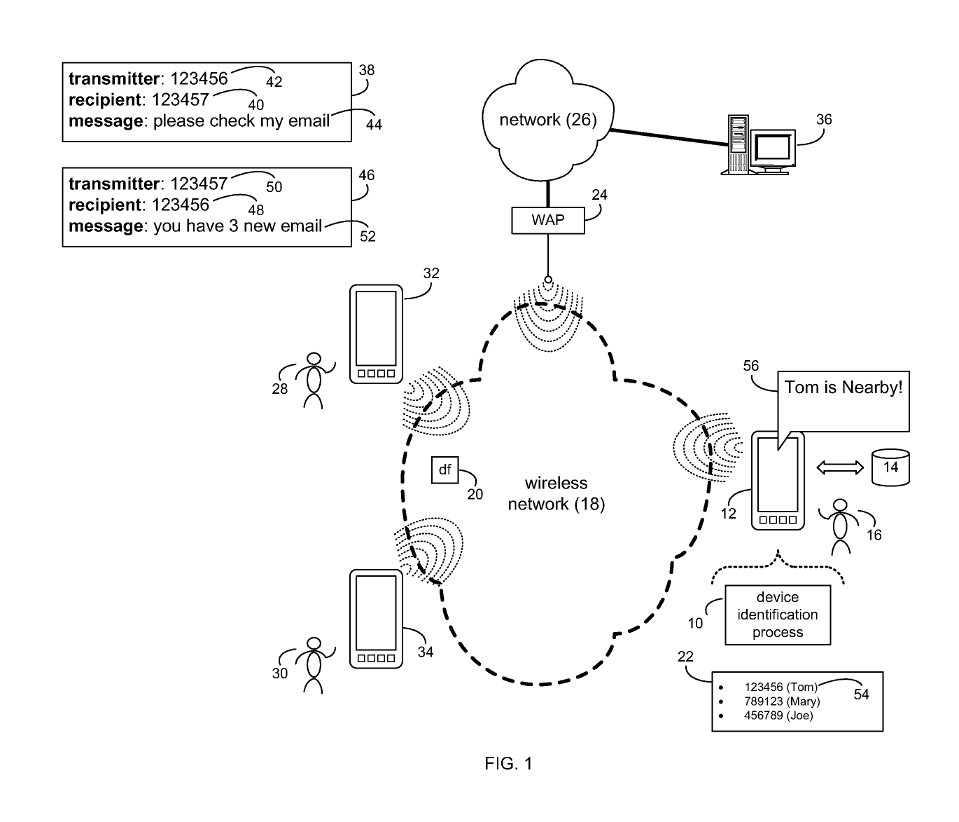

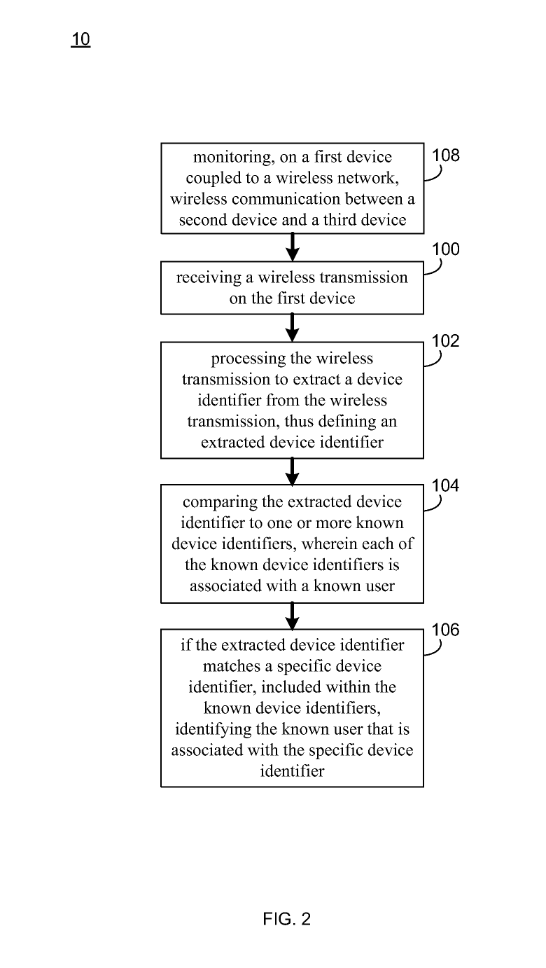

In FIGS. 1-2, there is shown device identification process 10. Device identification process 10 may be a client-side application and may reside on and may be executed by client electronic device 12. Examples of client electronic device 12 may include, but are not limited to: a data-enabled, cellular telephone; a smart phone; a tablet computer; a laptop computer; a notebook computer; a personal digital assistant; a personal computer; and a portable gaming console.

The instruction sets and subroutines of device identification process 10, which may be stored on storage device 14 coupled to client electronic device 12, may be executed by one or more processors (not shown) and one or more memory architectures (not shown) included within client electronic device 12. Examples of storage device 14 may include but are not limited to: a hard disk drive; an optical drive; a random access memory (RAM); a read-only memory (ROM); and all forms of flash memory storage devices.

Client electronic device 12 may be configured to allow user 16 to access wireless network 18. For example, client electronic device 12 may be an IEEE 802.11a, 802.11b, 802.11g, 802.11n, Wi-Fi, and/or Bluetooth device that is capable of wirelessly coupling client electronic device 12 to wireless network 18. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As will be discussed below in greater detail, device identification process 10 may be configured to notify user 16 of client electronic device 12 when their friends, colleagues, and acquaintances are nearby. Specifically, device identification process 10 may receive 100 a wireless transmission (e.g., data frame 20) on client electronic device 12 that is coupled to wireless network 18. This wireless transmission (e.g., data frame 20) may be processed 102 to extract a device identifier (e.g., a MAC address) from the wireless transmission (e.g., data frame 20), thus defining an extracted device identifier. This extracted device identifier may be compared 104 to one or more known device identifiers (e.g., known device identifiers 22), each of which is associated with a known user (e.g., their friends, colleagues, and acquaintances of user 16). If the extracted device identifier matches a specific device identifier (included within known device identifiers 22), the known user that is associated with the specific device identifier may be identified 106 to user 16 of client electronic device 12.

Wireless network 18 may include wireless access point 24 that may be coupled to network 26. Examples of network 26 may include but are not limited to: a local area network; a wide area network; an intranet; or the internet. Wireless access point 24 may be configured to allow users (e.g., user 16) to couple to wireless network 18 and network 26. Examples of wireless access point 24 may include but are not limited to an IEEE 802.11a, 802.11b, 802.11g, 802.11n, Wi-Fi, and/or Bluetooth device that is capable of wirelessly coupling e.g., client electronic device 12 to wireless network 18

Assume for illustrative purposes that users 28, 30 are accessing wireless network 18 via client electronic device 32. 34 (respectively). For example, user 28 may be accessing their email (e.g., which may be located on email server 36) via client electronic device 32. When user 28 accesses their email, one or more data frames (such as data frame 20) may be passed between client electronic device 32 and email server 36. As is known in the art, a data frame (e.g., data frame 20) is a portion of digital data that is transmitted through a data network, typically using Layer 2 of the OSI (Open Systems Interconnection) model. These data frames (e.g., data frame 20) may be configured in a manner similar to a traditional message, wherein the data frame (e.g., data frame 20) may define: a transmitter of data frame 20; an intended recipient of data frame 20; and a message. When identifying the transmitter and intended recipient of a data frame, MAC addresses may be used. As is known in the art, MAC addresses are unique identifiers that are associated with a network device. MAC addresses are typically hardware addresses (e.g., twelve digit hexadecimal numbers) that operate within Layer 2 of the OSI (Open Systems Interconnection) model and uniquely identify a device within a network.

While the following discussion is intended to illustrate the manner in which messages are passed between devices (e.g., client electronic device 32 and email server 36), this example is greatly simplified for illustrative purposes. For example, a single message may be made up of many data frames, each of which may include only a small portion of the actual message. Additionally, the MAC addresses are going to be represented as simple six digit numbers, while they are typically twelve digit hexadecimal numbers)

Continuing with the above-stated example, if user 28 wants to check their email using client electronic device 32, client electronic device 32 may send data frame 38 to email server 36. Data frame 38 may include first device identifier 40, which may be the MAC address (e.g., 123457) of email server 36 (i.e., the intended recipient of data frame 38). Additionally, data frame 38 may include second device identifier 42, which may be the MAC address (e.g., 123456) of client electronic device 32 (i.e., the transmitter of data frame 38). Further, data frame 38 may include message 44, which may be all or a portion of the message (e.g., “please check my email”) that the transmitter is providing to the intended recipient of data frame 38.

Email server 36 may receive and process data frame 38 and generate a response (in the form of data frame 46). Data frame 46 may include first device identifier 48, which may be the MAC address (e.g., 123456) of client electronic device 32 (i.e., the intended recipient of data frame 46). Additionally, data frame 46 may include second device identifier 50, which may be the MAC address (e.g., 123457) of email server 36 (i.e., the transmitter of data frame 46). Further, data frame 46 may include message 52, which may be all or a portion of the message (e.g., “you have 3 new email”) that the transmitter is providing to the intended recipient of data frame 46.

Additionally/alternatively, client electronic devices 32. 34 may directly communicate with each other. Therefore, data frames (such as data frame 20) may be provided directly for client electronic device 32 to client electronic device 34 and/or from client electronic device 34 to client electronic device 32. Accordingly, communication between client electronic device need to be made through a wireless access point (e.g., WAP 24), as in the above-described situation in which client electronic device 32 is communicating with email server 36.

When a client electronic device is coupled to wireless network 18, the device identifiers (e.g., device identifiers 40, 42 included within data frame 38 and device identifiers 48, 50 included within data frame 46) included within a data frame are viewable by all client electronic devices coupled to wireless network 18. Specifically, any device may examine the data frames being transmitted through wireless network 18 to determine the client electronic devices that are parties to those data frames.

Accordingly, device identification process 10 may be configured to monitor 108 wireless communication on wireless network 18 and notify user 16 of client electronic device 12 when their friends, colleagues, and acquaintances are nearby (e.g., coupled to wireless network 18, which has a defined and limited overage area).

Therefore, since client electronic device 12 of user 16 is coupled to wireless network 18, device identification process 10 may monitor 108 the above-described data frames (e.g., data frames 20, 38, 46). Continuing with the example in which client electronic device 32 is communicating with email server 36, device identification process 10 may receive 100 a wireless transmission (e.g., data frames 38) on a first device (e.g., client electronic device 12) coupled to wireless network 18.

Device identification process 10 may then process 102 the wireless transmission (e.g., data frames 38) to extract a device identifier from the wireless transmission (e.g., data frames 38), thus defining an extracted device identifier. As discussed above, data frame 38 may include first device identifier 40, which may be the MAC address (e.g., 123457) of email server 36 (i.e., the intended recipient of data frame 38) and second device identifier 42, which may be the MAC address (e.g., 123456) of client electronic device 32 (i.e., the transmitter of data frame 38). Accordingly, the extracted device identifier may be (in the example and for data frame 38) 123456 and 123457.

Client electronic device 12 may include one or more known device identifiers (e.g., known device identifiers 22), each of which may be associated with a known user (e.g., their friends, colleagues, and acquaintances of user 16). Accordingly, assume that user 16 is friends with user 28 (who is named Tom), user 32 (who is named Mary), and Joe. Known device identifiers 22 may associate these users with the MAC addresses of their client electronic devices. For example, the MAC address of client electronic device 32, which is used by Tom (user 28) is 123456; the MAC address of client electronic device 34, which is used by Mary (user 30) is 789123; and the MAC address of the client electronic device (not shown) that is used by Joe (not shown) is 456789.

Known device identifiers 22, which may be stored on storage device 14 coupled to client electronic device 12, may be configured as a list or a table. Known device identifiers 22 may be manually or automatically generated. For example, user 16 may ask Tom, Mary and Joe to provide him with the MAC address of their client electronic devices (which may be determinable via a configuration screen on the client electronic devices). Alternatively, device identification process 10 may be configured to (e.g., upon receiving a data frame addressed to client electronic device 12) ask user 16 if they wish to add the MAC address of the transmitter of the received data frame to known device identifiers 22.

Device identification process 10 may compare 104 the extracted device identifier (e.g., 123456 and 123457) to one or more known device identifiers 22 (e.g., 123456, 789123, 456789) to determine if a match exists.

If the extracted device identifiers (e.g., 123456 and 123457) do not match any of the known device identifiers 22 (e.g., 123456, 789123, 456789), device identification process 10 may continue to operate in the background and no notifications may be provided to user 16.

However, in this case, there is a match between the extracted device identifiers (e.g., 123456 and 123457) and known device identifiers 22. Specifically, the extracted device identifier 123456 is present within the list of known device identifiers 22. Accordingly, since the extracted device identifier (e.g., 123456) matches a specific device identifier (e.g., specific device identifier 54) included within known device identifiers 22, device identification process 10 may identify 106 the known user (e.g., Tom) that is associated with specific device identifier 54. For example, device identification process 10 may render popup notification 56 on the display of client electronic device 12 to inform user 16 that “Tom is Nearby!”

As discussed above, client electronic devices 32. 34 may directly communicate with each other. Therefore, data frames (such as data frame 20) may be provided directly for client electronic device 32 to client electronic device 34 and/or from client electronic device 34 to client electronic device 32. Accordingly, device identification process 10 may also process those directly-communicated data frames in the above-described manner.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

1. A computer-implemented method comprising:
monitoring, on a first device coupled to a wireless network, wireless communication between a second device and a third device, the first device being associated with a first user;
receiving, on the first device, a wireless transmission from the second device to the third device;
processing the wireless transmission to extract a device identifier from the wireless transmission, thus defining an extracted device identifier, wherein the extracted device identifier includes a MAC address, wherein the extracted device identifier defines one of a transmitter of the wireless transmission and an intended recipient of the wireless transmission;
comparing the extracted device identifier to one or more known device identifiers stored within the first device, wherein each of the known device identifiers is associated with a second user, the second user being known to the first user;
if the extracted device identifier matches a specific device identifier included within the known device identifiers, identifying the second user that is associated with the specific device identifier, and
providing for display on the first device a notification that the second user is coupling to the wireless network.

2. A computer-implemented method comprising:
monitoring, on a first device coupled to a wireless network, wireless communication between a second device and a third device, the first device being associated with a first user;
receiving, on the first device, a wireless transmission from the second device to the third device;
processing the wireless transmission to extract a device identifier from the wireless transmission, thus defining an extracted device identifier;
comparing the extracted device identifier to one or more known device identifiers, wherein each of the known device identifiers is associated with a second user, the second user being known to the first user;
if the extracted device identifier matches a specific device identifier included within the known device identifiers, identifying the second user that is associated with the specific device identifier; and
providing for display on the first device a notification that the second user is coupling to the wireless network.

3. The computer-implemented method of claim 2 wherein the wireless transmission includes at least one data frame.

4. The computer-implemented method of claim 2 wherein the second device and the third device are coupled to the wireless network.

5. The computer-implemented method of claim 2 wherein at least one of the second device and the third device is a client electronic device.

6. The computer-implemented method of claim 2 wherein at least one of the second device and the third device is a wireless access point.

7. The computer-implemented method of claim 2 wherein the extracted device identifier defines a transmitter of the wireless transmission.

8. The computer-implemented method of claim 2 wherein the extracted device identifier defines an intended recipient of the wireless transmission.

9. The computer-implemented method of claim 2 wherein the extracted device identifier includes a MAC address.

10. The computer-implemented method of claim 2 wherein the known device identifiers are stored within the first device.

11. A computing system including a processor and memory configured to perform operations comprising:
monitoring, on a first device coupled to a wireless network, wireless communication between a second device and a third device, the first device being associated with a first user;
receiving, on the first device, a wireless transmission from the second device to the third device;
processing the wireless transmission to extract a device identifier from the wireless transmission, thus defining an extracted device identifier;
comparing the extracted device identifier to one or more known device identifiers, wherein each of the known device identifiers is associated with a second user, the second user being known to the first user;
if the extracted device identifier matches a specific device identifier included within the known device identifiers, identifying the second user that is associated with the specific device identifier; and
providing for display on the first device a notification that the second user is coupling to the wireless network.

12. The computing system of claim 11 wherein the wireless transmission includes at least one data frame.

13. The computing system of claim 11 wherein the second device and the third device are coupled to the wireless network.

14. The computing system of claim 11 wherein at least one of the second device and the third device is a client electronic device.

15. The computing system of claim 11 wherein at least one of the second device and the third device is a wireless access point.

16. The computing system of claim 11 wherein the extracted device identifier defines a transmitter of the wireless transmission.

17. The computing system of claim 11 wherein the extracted device identifier defines an intended recipient of the wireless transmission.

18. The computing system of claim 11 wherein the extracted device identifier includes a MAC address.

19. The computing system of claim 11 wherein the known device identifiers are stored within the first device.
